(19) United States
(12) Patent Application Publication
(10) Pub. No.: US 2007/0279179 A1
(43) Pub. Date: Dec. 6, 2007

(54) Magnetic core for transformer

(75) Inventor: Yasushi Sasaki, Saitama (JP)

Correspondence Address: DENNIS G. LAPOINTE;LAPOINTE LAW GROUP, PL, PO BOX 1294, TARPON SPRINGS, FL, 34688-1294, US

(73) Assignee: TAMURA CORPORATION, Tokyo (JP)

(21) Appl. No.: 11/879,471

(22) Filed: Jul. 17, 2007

(30) Foreign Application Priority Data
Jan. 19, 2006 (JP) PCT/JP2006/301175
Jan. 20, 2005 (JP) 2005-012835

(51) Int. Cl. H01F 27/24

(52) U.S. Cl. 336/212

(57) ABSTRACT

A magnetic core for a transformer is composed of an I-shaped core (1) and two C-shaped cores (2, 3), which are arranged to sandwich a leading edge of the I-shaped core (1) from the both sides. The leading edge of the I-shaped core (1) is formed to have a curved shape, and leading edges of the two C-shaped cores (2, 3) are formed in a shape for fitting the leading edge of the I-shaped core (1), and a connecting section of the I-shaped core (1) and the C-shaped cores (2, 3) is formed to have a curved shape. Thus, the magnetic core having a small magnetic resistance and a high efficiency is provided for a transformer.

### FIELD OF THE INVENTION

This invention relates to a magnetic core for a transformer, with coils wound thereon.

### DESCRIPTION OF RELATED ART

Among the magnetic cores for power-source transformers, there is a type of a core formed from an E-shaped core and an I-shaped core. In the EI type core formed with these two cores, as shown in FIG. 16, an I-shaped core 102 is fixed to the three legs of an E-shaped core 101. And, as has been well known, coils (illustration omitted) are inserted on a middle leg 101A of the E-shaped core 101 as fitted within windows 103 of the EI type core, so as to constitute a transformer. With the magnetic cores of such structure, there is a problem that a large magnetic resistance against the flux generated by the coils hinders the building up of the flux, because the joining face 101B of the EI type core is of rectilinear shape, and the end face of the middle leg 101A is in contact therewith. This results in enlargements of an excitation current and a magnetostriction, and causes increase of vibrations and leakage flux, which leads to a risk of adversely affecting a unit having this transformer.

There has been a magnetic core as followings, which has solved such concerns as in the above (Patent Publication 1). In this magnetic core, C-shaped cores are provided on both sides of an I-shaped core. Further, at portions where the C-shaped cores join with the I-shaped core (hereinafter referred to as “joining portions”), both tip ends of the I-shaped core are formed into a wedge shape which comprises a combination of straight lines, and both tip ends of the C-shaped core are formed into a shape which engage with the wedge shape of the I-shaped core. In such cores, joining area of the I-shaped core and the C-shaped core at the joining portions is increased, which decreases the magnetic resistance.

Patent Literature 1: Japanese Patent Application, Publication No. 06-96963A

### PROBLEMS TO BE SOLVED BY THE INVENTION

Now, as with the reduction of weight and thickness of the units employing an electromagnetic device such as a transformer having an above described magnetic core, it has been demanded to further reduce the heat generation of the magnetic cores, the external radiation of the magnetic flux and so on, than in the case of the conventional art disclosed in the Patent Publication 1. That is, it is demanded to reduce the magnetic resistance of the magnetic cores.

The present invention solves the foregoing problems and provides a magnetic core for a transformer with which the reduction of the magnetic resistance can be realized.

### MEANS FOR SOLVING THE PROBLEMS

In order to solve the foregoing problems, the invention of claim 1 is a magnetic core for a transformer having an I-shaped core 1 and two C-shaped cores 2, 3 respectively disposed on both sides of the I-shaped core 1, characterized in that both side portions of each tip end of the I-shaped core 1 and opposing portions of the C-shaped cores 2, 3 respectively facing the side portions are formed in a shape that is a combination of curving lines and substantially straight lines, with a greater part of the opposing portions being made to be of the curving lines, for enlarging joining areas of both cores.

The invention of claim 2 is the magnetic core for the transformer of claim 1, characterized in that tip ends 11A₁, 11B₁ of the I-shaped core 1 are made in a substantially projecting shape, inner portions 11A₄, 11A₅, 11B₄, 11B₅ of the substantially projecting shape are made arcuate, and further inner portions 11A₆, 11A₇, 11B₆, 11B₇ extending toward inside surfaces of the C-shaped cores 2, 3 are made arcuate in reverse directions, for forming substantially S-shaped curving lines.

The invention of claim 3 is the magnetic core for the transformer of claim 2, characterized in that an arc of the substantially concave inner portions 11A₄, 11A₅, 11B₄, 11B₅ of the I-shaped core 1 and an arc of the further inner and oppositely arcuate portions are substantially of a same radius.

The invention of claim 4 is the magnetic core for the transformer disclosed in any one of claims 1-3, characterized in that a shape of tip ends of the substantially projecting tip end portions 11A₁, 11B₁ is made arcuate or flat, and the tip ends are made not projecting out of exterior face of the C-shaped cores 2, 3 and not in contact with the C-shaped cores 2, 3.

The invention of claim 5 is the magnetic core for the transformer disclosed in claim 2 or 3, characterized in that engaging portions 11A₂, 11A₃, 11B₂, 11B₃ are formed as projections with a tip of rounded shape, provided on both side portions inside of the tip ends of the tip end portions 11A₁, 11B₁ of the I-shaped core 1, and engaging portions are also formed in corresponding tip end portions 21A₁ of the C-shaped cores 2, 3 for engaging with the engaging portions 11A₂, 11A₃, 11B₂, 11B₃ of the I-shaped core 1.

The invention of claim 6 is the magnetic core for the transformer disclosed in claim 4, characterized in that engaging portions 11A₂, 11A₃, 11B₂, 11B₃ are formed as projections with a tip of rounded shape, provided on both side portions inside of the tip ends of the tip end portions 11A₁, 11B₁ of the I-shaped core 1, and engaging portions are also formed in corresponding tip end portions 21A₁ of the C-shaped cores 2, 3 for engaging with the engaging portions 11A₂, 11A₃, 11B₂, 11B₃ of the I-shaped core 1.

### EFFECT OF THE INVENTION

According to the invention of claims 1 and 2, the joining portions, along which the I-shaped core and the two C-shaped cores are joined together are formed in the curved shape, so that each contacting area between two of the cores is enlarged, and the magnetic resistance at the joining parts can be reduced. As a result, the flows of the magnetic flux across the joining portions are improved, and a highly efficient transformer can be realized. In particular, as the magnetizing force is reduced, the vibration can be suppressed, and the occurrence of beat can be prevented. Further, because of the low leakage magnetic flux, anti-magnetic measures can be made unnecessary.

According to the invention of claim 3, the curved configuration of the I-shaped core is made arcuate, and the respective portions are made to be substantially of a same radius, so that working and processing with respect to the tip ends of the I-shaped core and the C-shaped cores can be made easier.

In the invention of claim 4, the substantially projecting tip end portions of the I-shaped core are made to be not in contact with the C-shaped cores to have a clearance, to improve the assembling efficiency by making them suitable for fitting and engaging on joining of the I-shaped core and the C-shaped cores.

According to the invention of claims 5 and 6, the joining portions are provided with the engaging portions, so that the fastening of the I-shaped core and the C-shaped cores can be strengthened.

### BRIEF DESCRIPTION OF THE DRAWINGS

FIG. 1 is a plan view showing the magnetic core for the transformer according to the present embodying mode;

FIG. 2 is a plan view showing the I-shaped core in FIG. 1;

FIG. 3 is an enlarged view of the tip end of the core in FIG. 2;

FIG. 4 is a plan view showing a first one of the C-shaped core in FIG. 1;

FIG. 5 is an enlarged view of the tip end of the core in FIG. 4;

FIG. 6 is an explanatory view for dimensions of the joining parts in FIG. 1;

FIG. 7 is an explanatory view for explaining a practical example of the tip end in the I-shaped core according to Embodiment 1;

FIG. 8 is an explanatory view for explaining a practical example of the tip end in the first and second C-shaped cores according to Embodiment 1;

FIG. 9 is a diagram of the flux density distribution in the magnetic core for the transformer according to Embodiment 2;

FIG. 10 is a diagram showing lines of magnetic induction in the magnetic core for the transformer according to Embodiment 2;

FIG. 11 is a diagram of the flux density distribution in the external space of the core according to Embodiment 2;

FIG. 12 is a diagram of superposition of the flux density and the lines of magnetic induction according to Embodiment 3;

FIG. 13 is a diagram of the flux density distribution in the external space of the core according to Embodiment 3;

FIG. 14 is a diagram of superposition of the flux density and the lines of magnetic induction according to a conventional art;

FIG. 15 is a diagram of the flux density distribution in the external space of the core according to the conventional art; and

FIG. 16 is a plan view showing a conventional EI type core.

### THE BEST MODE FOR CARRYING OUT THE INVENTION

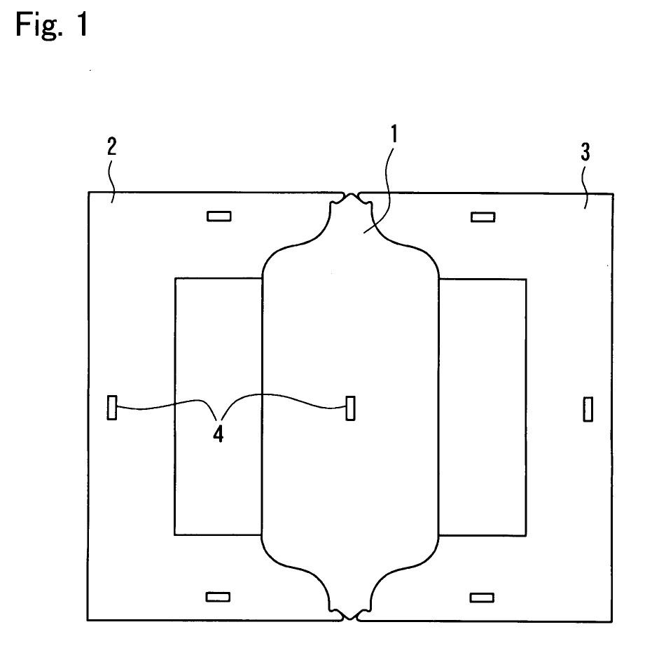

Next, an embodying mode of the present invention shall be explained in detail with reference to the drawings. The magnetic core for a transformer according to the present embodying mode is shown in FIG. 1. This magnetic core for a transformer comprises an I-shaped core 1 disposed in the center, as well as a first C-shaped core 2 and a second C-shaped core 3 which are respectively disposed on each side of the I-shaped core 1. In FIG. 1, a reference numeral 4 denotes caulking.

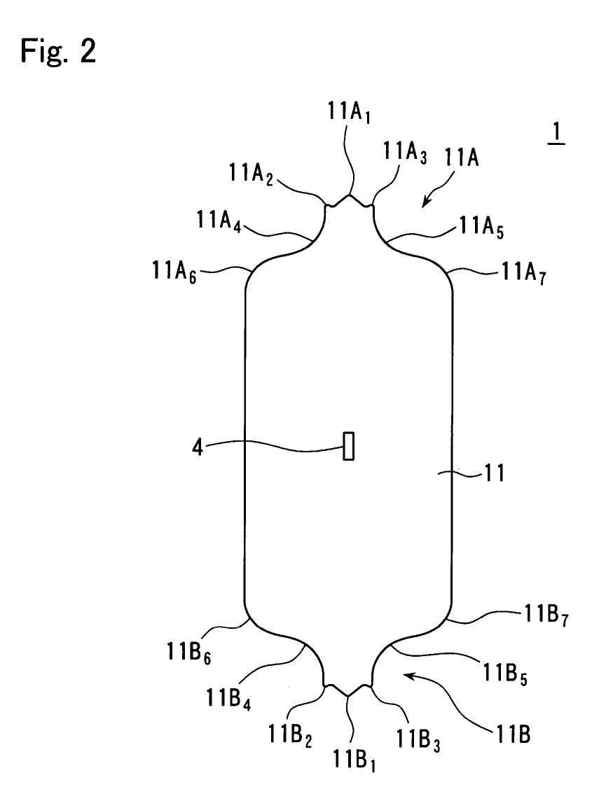

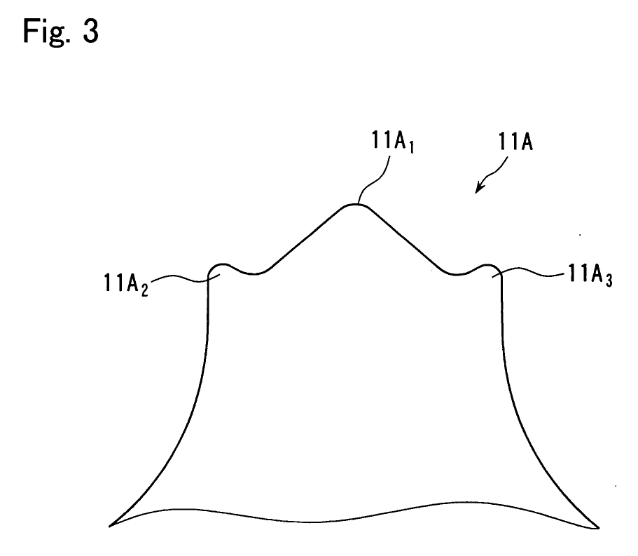

The I-shaped core in the present invention is featured in that it is not of an exact I-shape, but, as shown in FIG. 2, formed in a shape where, in each tip end portion of the bar shaped main body 11, a little portion of each side is substantially straight and a greater portion is curvilinear. The first and second C-shaped cores 2, 3 are formed in a corresponding shape in portions to be joined with the straight and curved portions. That is, a first tip end of the main body is formed substantially in a projecting shape, and the projecting end 11A is formed in a shape which becomes narrower toward the tip end. Further, as shown more in detail in FIG. 3, the tip end portion 11A₁ of the projecting end 11A is rounded. At the foot parts on the respective sides of the projecting end 11A, substantially triangular engaging portions 11A₂, 11A₃ are formed. The engaging portion 11A₂ is for engaging with the first C-shaped core 2, while the engaging portion 11A₃ is for engaging with the second C-shaped core 3. These engaging portions 11A₂, 11A₃ are also rounded at their tip ends. Similarly, inner corner portions 11A₄, 11A₅ of the projecting end 11A are also curvilinear, and further inner ridge portions 11A₆, 11A₇ of the projecting end 11A are also curvilinear, while the tip end portion of the projecting end 11A may be formed to be flat.

In such manner, the first tip end of the main body 11 is of a curvilinear shape. Similarly, the other tip end of the main body 11 is of the curvilinear shape. That is, in the other projecting end 11B, tip end portion 11B₁, engaging portions 11B₂, 11B₃, corner portions 11B₄, 11B₅ and ridge portions 11B₆, 11B₇ are respectively corresponding to the first projecting end 11A, tip end portion 11A₁, engaging portions 11A₂, 11A₃, corner portions 11A₄, 11A₅ and the ridge portions 11A₆, 11A₇.

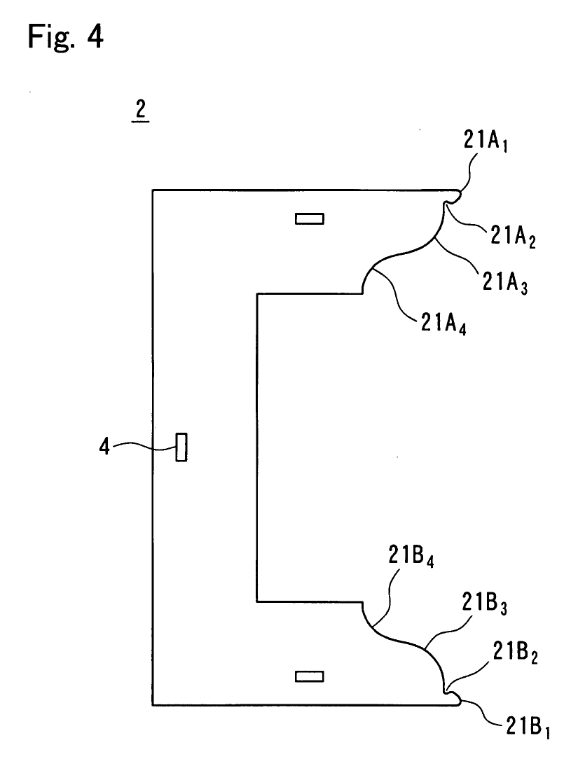

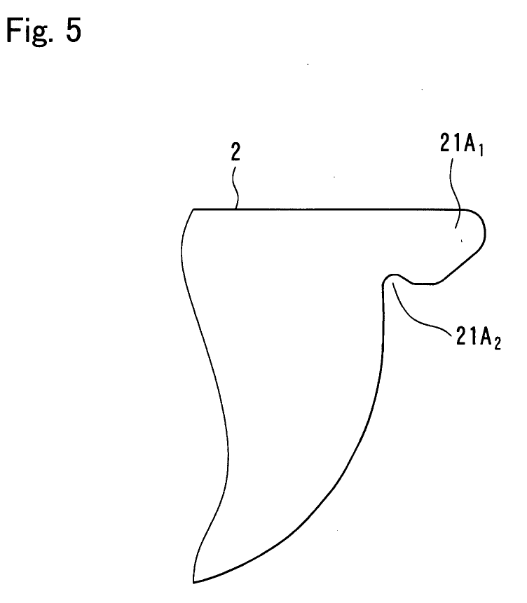

In the present embodying mode, both sides of the respective tip ends of the main body 11 are respectively formed in a curvilinear shape in which arcs in opposite directions are combined to form substantially an S-shape as a whole. And by this, the contacting area of the joining portions along which the I-shaped core 1 contacts with the first C-shaped core 2 and with the second C-shaped core 3 can be enlarged. Each tip end of the first C-shaped core 2 is formed, as shown in FIG. 4, in a shape engageable with each tip end of the I-shaped core 1. That is, as shown more in detail in FIG. 5, a tip end portion 21A₁ of the first C-shaped core 2 has a projecting shape to engage with the tip end portion 11A₁ of the I-shaped core 1, and a concave engaging portion 21A₂ of the first C-shaped core 2 positioned inner side of the tip end portion 21A₁ is of a shape to engaging with the projecting engaging portion 11A₂ of the I-shaped core 1 shown in FIG. 1 or in FIG. 3. With the engaging portion 21A₂ of the first C-shaped core 2 and the engaging portion 11A₂ of the I-shaped core 1, the mechanical coupling of these two cores is performed. That is, with its nail-shaped structure, the engaging portion 11A₂ of the I-shaped core 1 makes two methods possible: a method in which the engaging portion 11A₂ is pushed into the engaging portion 21A₂ of the first C-shaped core 2, and a method in which these two engaging portions are welded together at the tip ends. With these engaging portions, it is made possible to reinforce the joining of the joining portions.

Further, a curving convex portion 21A₃ of the first C-shaped core 2 on inner side of the engaging portion 21A₂ is of a shape fit in the corner portion 11A₄ of the I-shaped core 1 formed to correspond thereto, and a curved concave portion 21A₄ of the first C-shaped core 2 is of a shape fit with the ridge portion 11A₆ of the I-shaped core 1.

Similarly, a tip end portion 21B, of the first C-shaped core 2 is of a shape fit with the tip end portion 11B₁ of the I-shaped core 1, and a concave engaging portion 21B₂ of the first C-shaped core 2 is of a shape fit with the engaging portion 11B₂ of the I-shaped core 1.

Further, a curving convex portion 21B₃ of the first C-shaped core 2 is of a shape fit in the corner portion 11B₄ of the I-shaped core 1, and a curved concave portion 21B₄ of the first C-shaped core 2 is of a shape fit with the ridge portion 11B₆ of the I-shaped core 1.

Since the second C-shaped core 3 is identical to the first C-shaped core 2, detailed description thereof shall be omitted.

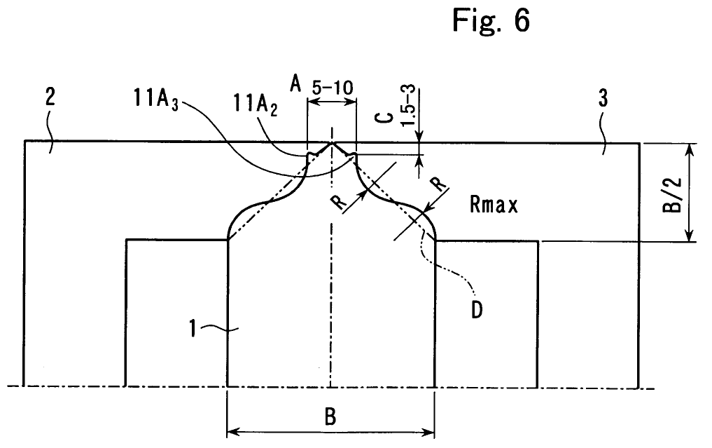

In this manner, according to the present embodying mode, the I-shaped core 1 is put in engagement with the first C-shaped core 2 and with the second C-shaped core 3, to be unified, and a magnetic core for a transformer is formed. In here, the substantially convex tip ends of the I-shaped core 1 are so dimensioned as not to project out of the outer face of the C-shaped cores 2, 3. Also, the substantially convex tip ends of the I-shaped core are made to be not in contact with the C-shaped cores 2, 3, to make the fitting easier. If there is no clearance, even a small dimensional error makes the fitting uneasy and leads to a poor assembling efficiency, whereas these kinds of problems do not happen in the present invention. In here, such values as shown in FIG. 6 are suitable, regarding the respective dimensions of the projecting end 11A of the I-shaped core 1, as well as a radius R in case of forming the corner portions 11A₄, 11A₅, 11B₄, 11B₅ in arcs, and a radius R in case of forming the ridge portions 11A₆, 11A₇, 11B₆, 11B₇ in arcs. That is, the projecting end 11A is made to be of a width of a value A, and the I-shaped core 1 is made to be of a width of a value B. Then, the width A will be a value variable from 5 to 10 [mm] depending on the core size, and the width B is a value determined by the core size.

With these width values A and B, the length of the radius R, Rmax, determined for each core size will be given by
Rmax=(B−A)/4

and a width E of the first and second C-shaped cores 2, 3 will be given by
E=B/2

Then, the value Rmax is calculated by these formulas and provides the center of a provisional curve. Given that the length D of a straight line drawn diagonally from the center line of the I-shaped core 1 is the shortest distance, a length of the curving line calculated by the value Rmax is made to be in the range from the straight line length D×1.01 to D×1.25. Further, the projecting portion 11A of the I-shaped core 1 is formed so as to become narrower towards the tip end. In here, a distance from a bottom ground of the engaging portion 11A₂ or 11A₃ to the end face of the first C-shaped core 2 or of the second C-shaped core 3 is made to be value C. This distance C is a value variable from 1.5 to 3 [mm] depending on the core size.

In this manner, according to the present embodying mode, both side portions of the tip end portion 11A₁ of the projecting end 11A of the I-shaped core 1, and their corresponding tip end portion 21A₁ of the C-shaped core 2 are made substantially rectilinear, while the other joining portions where the first and second C-shaped cores 2 and 3 are joined with the I-shaped core 1 are formed to be curvilinear, so that a greater portion is joined in curves. By this, the contacting area between the I-shaped core 1 and the first C-shaped core 2 as well as the contacting area between the I-shaped core 1 and the second C-shaped core 3 are made larger than in the case of conventional art (Patent Literature 1) and the magnetic resistance along the joining portions can be minimized. As a result, the magnetic fluxes across the joining portions are improved, and a highly efficient transformer, that is, a transformer with low leakage flux, low vibrations, low heat generation and small loss can be realized. In particular, as the magnetization force is minimized, the vibration can be restrained and any generation of hum can be restrained. Further, the low leakage flux renders such anti-magnetic measures as SR, HPB and so on unnecessary, and it is possible to realize a transformer which is simple and easy to manufacture.

Further, in case where the curved shape is made to be arcuate along the joining portions between the I-shaped core 1 and the first and second C-shaped cores 2 and 3, it is possible to attain an easier working of the joining portions between the I-shaped core 1 and the first and second C-shaped cores 2 and 3.

### EMBODIMENT 1

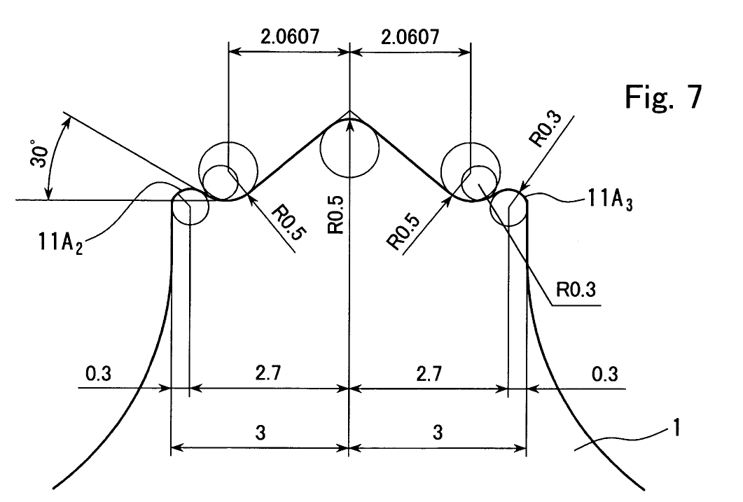

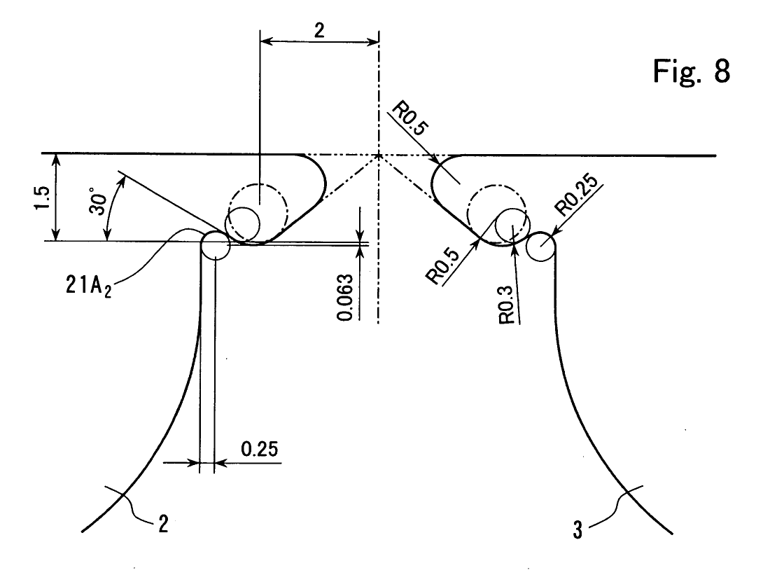

In this embodiment, the tip end portions of the I-shaped core 1 of the magnetic core for a transformer according to the present embodying mode, that is, respective portions shown in FIG. 3 are so dimensioned as shown in FIG. 7. Further, in the present embodiment, dimensions of the tip end of the first C-shaped core 2 (FIG. 5) and of the tip end of the second C-shaped core 3 are made as shown in FIG. 8. In this embodiment, the curves of the engaging portions 11A₂, 11A₃ of the I-shaped core 1 is formed arcuate, with a radius of value R0.3. Also, the curve of the engaging portion 21A₂ of the first C-shaped core 2 engaging with the engaging portion 11A₂ is formed arcuate, with a radius of value R0.25. This is applicable also to the second C-shaped core 3.

That is, in this embodiment, the dimensions of the engaging portions 11A₂, 11A₃ of the I-shaped core 1 and of the engaging portion 21A₂ of the first C-shaped core 2 as well as that of the second C-shaped core 3 are made different. That is, even in a case where the two engaging portions are only substantially engageable, they are within the range of the present invention.

### EMBODIMENT 2

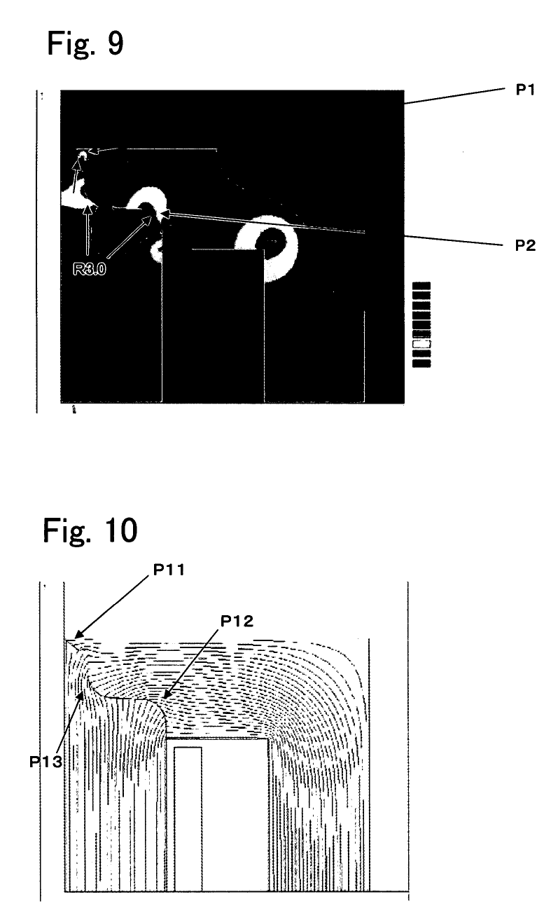

In this embodiment, explanations shall be made regarding an example where the ridge portions and the corner portions of the I-shaped core 1 are made to be of a radius of R3.0. FIG. 9 is a diagram of the magnetic flux density distribution in the magnetic core for a transformer according to this embodiment. While FIG. 9 and the following figures show, as an example, only one part of the fitting of the I-shaped core 1 and the second C-shaped core 3, same things can be said regarding the other engaging portions. Further in FIG. 9 and the following figures, an area of a color closer to blue indicates an area of more sparse magnetic fluxes, while a color closer to red indicates denser magnetic fluxes. As shown by arrow P1 in FIG. 9, there is provided a locking mechanism of a width between 1.5 and 3.0 [mm], the tip end of which is intercrossing with another on the centerline, for the purpose of maintaining the characteristics (the lowered magnetic resistance and so on) after the fitting and joining of the I-shaped core 1 with the second C-shaped core 3, as well as for the purpose of the mechanical engagement of the cores.

Further, as shown by arrow P2, there arise areas where the magnetic flux is thin as a whole, while there is a slight concentration of the magnetic flux.

FIG. 10 shows the state of the lines of magnetic flux in FIG. 9. As shown by arrow P11 in FIG. 10, the magnetic flux is effectively spreading over the magnetic path of the cores. With the radius of R3.0, there arise parts of a slight concentration of the magnetic flux, as shown by arrows P12 and P13.

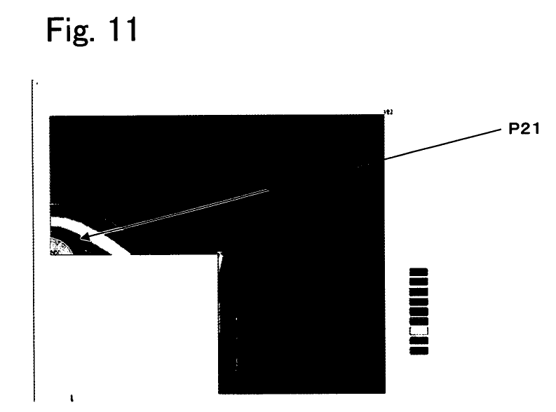

The magnetic flux density distribution in the exterior space of FIG. 9 is shown in FIG. 11. As indicated by arrow P21 in FIG. 11, the leakage flux is enlarged slightly at the tip end of the I-shaped core 1.

### EMBODIMENT 3

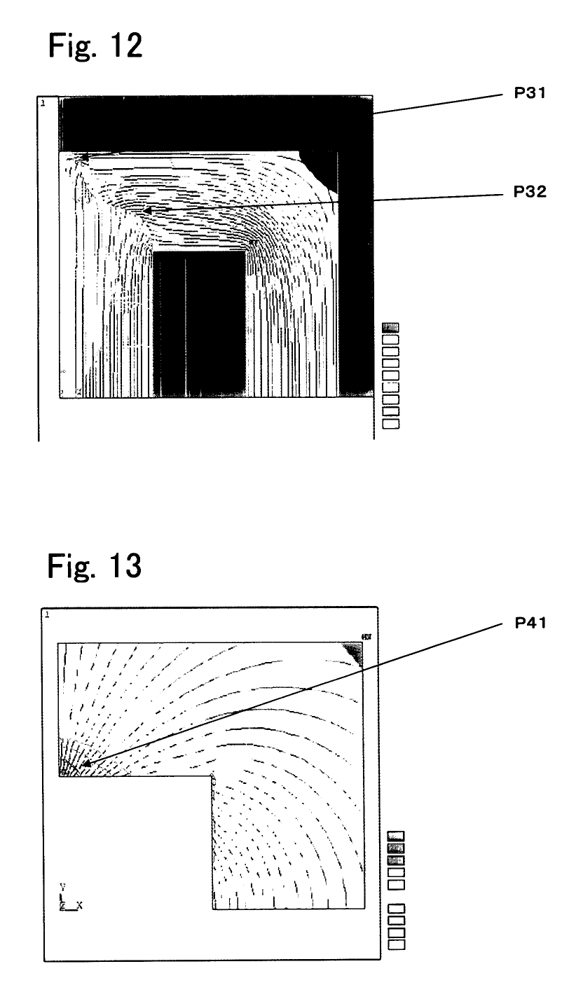

In this embodiment, descriptions shall be made on a case where the radius of the ridge and corner portions of the I-shaped core 1 is made R5.0. FIG. 12 is a diagram of the magnetic flux density distribution in the magnetic core for the transformer according to this embodiment. While the shape of the tip end of the I-shaped core 1 is same as in Embodiment 2 as shown by arrow P31, when the radius is enlarged, the regions of the ideal, green magnetic flux density increase over the entire magnetic path, with the slightly concentrating magnetic flux density disappeared as compared with Embodiment 2, as shown by arrow P32. Further, with the enlarged radius, being compared to Embodiment 2, the leakage magnetic flux is decreased at the tip end portion of the I-shaped core 1, as shown by arrow P41 in FIG. 13.

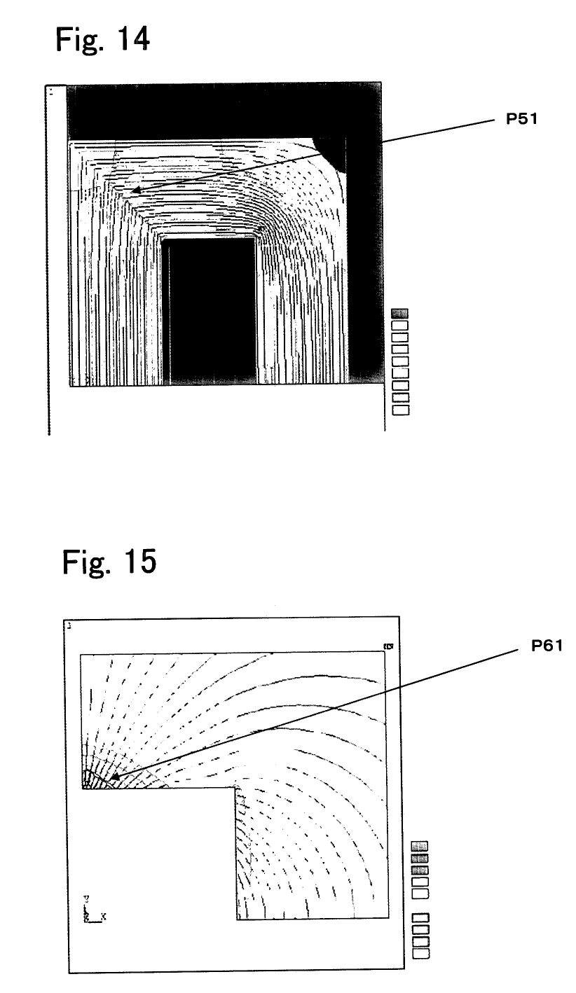

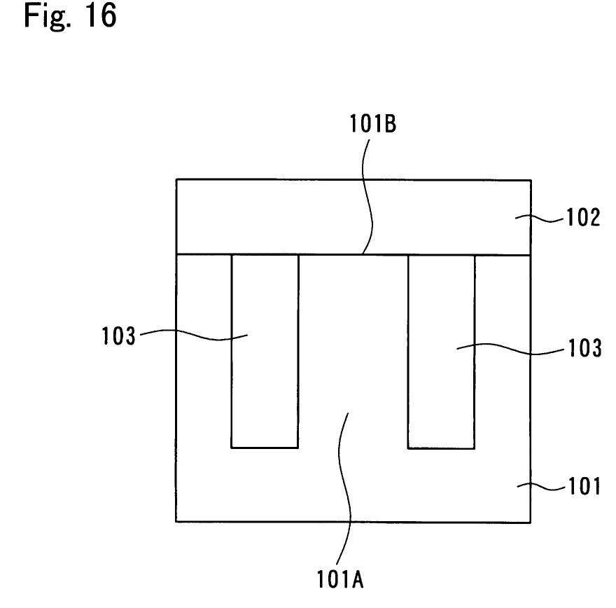

On the other hand, as shown with an arrow P51 in FIG. 14, the magnetic flux density distribution according to the prior art in which the tip end of the I-shaped core is of triangle shape (Patent Literature 1) involves much yellow region, and the magnetic flux distribution is higher than in the present embodiment. Further, as shown by an arrow P61 in FIG. 15, the leakage magnetic flux is also higher in the prior art than in the present embodiment. This is caused by that, in the present embodiment, the magnetic path is expanded because of the length of the joining portions made longer by 11.5 [%] than the prior art.

While in the above the working aspects and embodiments of the present invention have been disclosed in detail, practical arrangement should not be limited to these working aspects and embodiments, and any design modification or the like which does not deviate from the spirit of the present invention should be included in the present invention. For example, instead of the magnetic core for the transformer that has been disclosed, an application to a reactor is also possible.

### POSSIBLE UTILIZATION IN THE INDUSTRY

The magnetic core for the transformer to which the present invention relates is useful when employed in power-source transformers for use in small electronic device and equipments.

1. A magnetic core for a transformer comprising an I-shaped core (1) and two C-shaped cores (2, 3) respectively disposed on both sides of the I-shaped core (1), characterized in that both side portions of each tip end of the I-shaped core (1) and opposing portions of the C-shaped cores (2, 3) respectively facing the side portions are formed in a shape that is a combination of curving lines and substantially straight lines, with a greater part of the opposing portions being made to be of the curving lines, for enlarging joining area of both cores.

2. The magnetic core for the transformer disclosed in claim 1, characterized in that tip end portions (11A₁, 11B₁) of the I-shaped core (1) are made in a substantially projecting shape, inner portions (11A₄, 11A₅, 11B₄, 11B₅) of the substantially projecting shape are made arcuate, and further inner portions (11A₆, 11A₇, 11B₆, 11B₇) extending towards inside surfaces of the C-shaped cores (2, 3) are made arcuate in reverse directions, for forming substantially S-shaped curving lines.

3. The magnetic core for the transformer disclosed in claim 2, characterized in that an arc of the substantially concave inner portions (11A₄, 11A₅, 11B₄, 11B₅) of the I-shaped core (1) and an arc of the further inner and oppositely arcuate portions are substantially of a same radius.

4. The magnetic core for the transformer disclosed in claim 1, characterized in that a shape of tip ends of the substantially projecting tip end portions (11A₁, 11B₁) is made arcuate or flat, and the tip ends are made not projecting out of exterior faces of the C-shaped cores (2, 3) and not in contact with the C-shaped cores (2, 3).

5. The magnetic core for the transformer disclosed in claim 2, characterized in that engaging portions (11A₂, 11A₃, 11B₂, 11B₃) are formed as projections with a tip of rounded shape, provided on both side portions inside of the tip ends of the tip end portions (11A₁, 11B₁) of the I-shaped core (1), and engaging portions are also formed in corresponding tip end portions (21A₁) of the C-shaped cores (2, 3) for engaging with the engaging portions (11A₂, 11A₃, 11B₂, 11B₃) of the I-shaped core (1).

6. The magnetic core for the transformer disclosed in claim 4, characterized in that engaging portions (11A₂, 11A₃, 11B₂, 11B₃) are formed as projections with a tip of rounded shape, provided on both side portions inside of the tip ends of the tip end portions (11A₁, 11B₁) of the I-shaped core (1), and engaging portions are also formed in corresponding tip end portions (21A₁) of the C-shaped cores (2, 3) for engaging with the engaging portions (11A₂, 11A₃, 11B₂, 11B₃) of the I-shaped core (1).

7. The magnetic core for the transformer disclosed in claim 2, characterized in that a shape of tip ends of the substantially projecting tip end portions (11A₁, 11B₁) is made arcuate or flat, and the tip ends are made not projecting out of exterior faces of the C-shaped cores (2, 3) and not in contact with the C-shaped cores (2, 3).

8. The magnetic core for the transformer disclosed in claim 3, characterized in that a shape of tip ends of the substantially projecting tip end portions (11A₁, 11B₁) is made arcuate or flat, and the tip ends are made not projecting out of exterior faces of the C-shaped cores (2, 3) and not in contact with the C-shaped cores (2, 3).

9. The magnetic core for the transformer disclosed in claim 3, characterized in that engaging portions (11A₂, 11A₃, 11B₂, 11B₃) are formed as projections with a tip of rounded shape, provided on both side portions inside of the tip ends of the tip end portions (11A₁, 11B₁) of the I-shaped core (1), and engaging portions are also formed in corresponding tip end portions (21A₁) of the C-shaped cores (2, 3) for engaging with the engaging portions (11A₂, 11A₃, 11B₂, 11B₃) of the I-shaped core (1).

10. The magnetic core for the transformer disclosed in claim 7, characterized in that engaging portions (11A₂, 11A₃, 11B₂, 11B₃) are formed as projections with a tip of rounded shape, provided on both side portions inside of the tip ends of the tip end portions (11A₁, 11B₁) of the I-shaped core (1), and engaging portions are also formed in corresponding tip end portions (21A₁) of the C-shaped cores (2, 3) for engaging with the engaging portions (11A₂, 11A₃, 11B₂, 11B₃) of the I-shaped core (1).

11. The magnetic core for the transformer disclosed in claim 8, characterized in that engaging portions (11A₂, 11A₃, 11B₂, 11B₃) are formed as projections with a tip of rounded shape, provided on both side portions inside of the tip ends of the tip end portions (11A₁, 11B₁) of the I-shaped core (1), and engaging portions are also formed in corresponding tip end portions (21A₁) of the C-shaped cores (2, 3) for engaging with the engaging portions (11A₂, 11A₃, 11B₂, 11B₃) of the I-shaped core (1).
